(19) United States
(12) Patent Application Publication
(10) Pub. No.: US 2025/0220190 A1
(43) Pub. Date: Jul. 3, 2025

(54) VIDEO DECODING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Shenming Feng, Shenzhen (CN); Sihong Chen, Shenzhen (CN)

(73) Assignee: Tencent Technology (Shenzhen) Company Limited, Shenzhen (CN)

(21) Appl. No.: 19/042,088

(22) Filed: Jan. 31, 2025

Related U.S. Application Data
(63) Continuation of application No. PCT/CN2023/135898, filed on Dec. 1, 2023.

(30) Foreign Application Priority Data
Jan. 12, 2023 (CN) 202310074826.1

(51) Int. Cl. H04N 19/132; H04N 19/146; H04N 19/177; H04N 19/44

(52) U.S. Cl. CPC H04N 19/132; H04N 19/146; H04N 19/177; H04N 19/44

(57) ABSTRACT

A video decoding method includes performing video stream analysis on a to-be-decoded video to obtain a frame data packet of video frames in the to-be-decoded video; determining frame types of the video frames based on frame attribute information in the frame data packet; determining target sampling frames from the to-be-decoded video based on a quantity of key frames; obtaining rendering data from frame buffers; and performing video decoding on the to-be-decoded video based on the rendering data to obtain a decoded video corresponding to the to-be-decoded video.

### CROSS-REFERENCE TO RELATED APPLICATIONS

This application is a continuation application of International Application No. PCT/CN2023/135898 filed on Dec. 1, 2023, which claims priority to Chinese Patent Application No. 202310074826.1, filed with the China National Intellectual Property Administration on Jan. 12, 2023, the disclosures of each being incorporated by reference herein in their entireties.

### FIELD

The disclosure relates to Internet communications, a video decoding method and apparatus, an electronic device, a computer-readable storage medium, and a computer program product.

### BACKGROUND

Video decoding can be divided into two operations: In the first operation, a frame buffer of each video frame is decoded from a video stream; and in the second operation, the frame buffer is rendered as a complete image. In the first operation, decoding of different video frames depends on different associated frames. For example, in a related art, for an inputted to-be-decoded video, each video frame is first decoded from a video stream to obtain a corresponding frame buffer, and the frame buffer is stored in a cache. Then, a time stamp index of a video frame is calculated by using a uniform frame capture algorithm, and a corresponding frame buffer is selected for picture rendering according to the time stamp index.

However, in a video decoding method in a related art, the concept of a group of pictures (GOP) is not considered in a decoding process, and the “same” method is used for all video frames. In a frame buffer decoding process, all video frames may be decoded, resulting in a slow decoding speed. In addition, importance of a key frame is not considered, and a frame may be missed. For example, a short video frame whose picture changes greatly is missed and not decoded. It can be learned that problems of low decoding efficiency and decoding accuracy exist in the video decoding method in the related art.

### SUMMARY

Provided are a video decoding method and apparatus, an electronic device, a computer-readable storage medium, and a computer program product.

According to an aspect of the disclosure, a video decoding method, performed by an electronic device includes, performing video stream analysis on a to-be-decoded video to obtain a frame data packet of a first plurality of video frames in the to-be-decoded video, wherein the video stream analysis may include parsing an encapsulated data packet that encapsulates video frame information in the to-be-decoded video; determining a plurality of frame types of the first plurality of video frames based on frame attribute information in the frame data packet, a frame type including a key frame and a non-key frame; determining a first plurality of target sampling frames from the to-be-decoded video based on a first quantity of a plurality of key frames, the first plurality of target sampling frames being a second plurality of video frames configured for providing rendering data when rendering the to-be-decoded video, and the rendering data being stored in a plurality of frame buffers corresponding to the first plurality of target sampling frames; obtaining the rendering data from the plurality of frame buffers; and performing video decoding on the to-be-decoded video based on the rendering data to obtain a decoded video corresponding to the to-be-decoded video.

According to an aspect of the disclosure, a video decoding apparatus includes, at least one memory configured to store computer program code; and at least one processor configured to read the program code and operate as instructed by the program code, the program code including video stream analysis code configured to cause at least one of the at least one processor to perform video stream analysis on a to-be-decoded video to obtain a frame data packet of a first plurality of video frames in the to-be-decoded video, wherein the video stream analysis may include parsing an encapsulated data packet that encapsulates video frame information in the to-be-decoded video; first determining code configured to cause at least one of the at least one processor to determine a plurality of frame types of the first plurality of video frames based on frame attribute information in the frame data packet, a frame type including a key frame and a non-key frame; second determining code configured to cause at least one of the at least one processor to determine a first plurality of target sampling frames from the to-be-decoded video based on a first quantity of a plurality of key frames, the first plurality of target sampling frames being a second plurality of video frames configured for providing rendering data when rendering the to-be-decoded video, and the rendering data being stored in a plurality of frame buffers corresponding to the first plurality of target sampling frames; obtaining code configured to cause at least one of the at least one processor to obtain the rendering data from the plurality of frame buffers; and video decoding code configured to cause at least one of the at least one processor to perform video decoding on the to-be-decoded video based on the rendering data to obtain a decoded video corresponding to the to-be-decoded video.

According to an aspect of the disclosure, a non-transitory computer-readable storage medium, storing computer code which, when executed by at least one processor, causes the at least one processor to at least perform video stream analysis on a to-be-decoded video to obtain a frame data packet of a first plurality of video frames in the to-be-decoded video, wherein the video stream analysis may include parsing an encapsulated data packet that encapsulates video frame information in the to-be-decoded video; determine a plurality of frame types of the first plurality of video frames based on frame attribute information in the frame data packet, a frame type including a key frame and a non-key frame; determine a first plurality of target sampling frames from the to-be-decoded video based on a first quantity of a plurality of key frames, the first plurality of target sampling frames being a second plurality of video frames configured for providing rendering data when rendering the to-be-decoded video, and the rendering data being stored in a plurality of frame buffers corresponding to the first plurality of target sampling frames; obtain the rendering data from the plurality of frame buffers; and perform video decoding on the to-be-decoded video based on the rendering data to obtain a decoded video corresponding to the to-be-decoded video.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a frame decoding sequence in a related art.

FIG. 2 is a schematic flowchart of a video decoding method in a related art.

FIG. 3 is a diagram of a decoding comparison effect between some embodiments and a method in a related art.

FIG. 4 is an optional schematic architectural diagram of a video decoding system according to some embodiments.

FIG. 5 is a schematic structural diagram of an electronic device according to some embodiments.

FIG. 6 is an optional schematic flowchart of a video decoding method according to some embodiments.

FIG. 7 is another optional schematic flowchart of a video decoding method according to some embodiments.

FIG. 8 is a schematic diagram of determining a target sampling frame according to some embodiments.

FIG. 9 is a schematic diagram of determining target sampling frames that all come from key frames according to some embodiments.

FIG. 10 is a schematic diagram of determining target sampling frames from all key frames and some non-key frames according to some embodiments.

FIG. 11 is a schematic diagram of video decoding according to some embodiments.

FIG. 12 is a schematic diagram of an application process of a video decoding method according to some embodiments.

FIG. 13 is a decoding plus frame sampling process of a frame buffer according to some embodiments.

FIG. 14 is a schematic diagram of an application process of a video decoding method according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Before a video decoding method in some embodiments is explained, a video decoding process in a related art is first described.

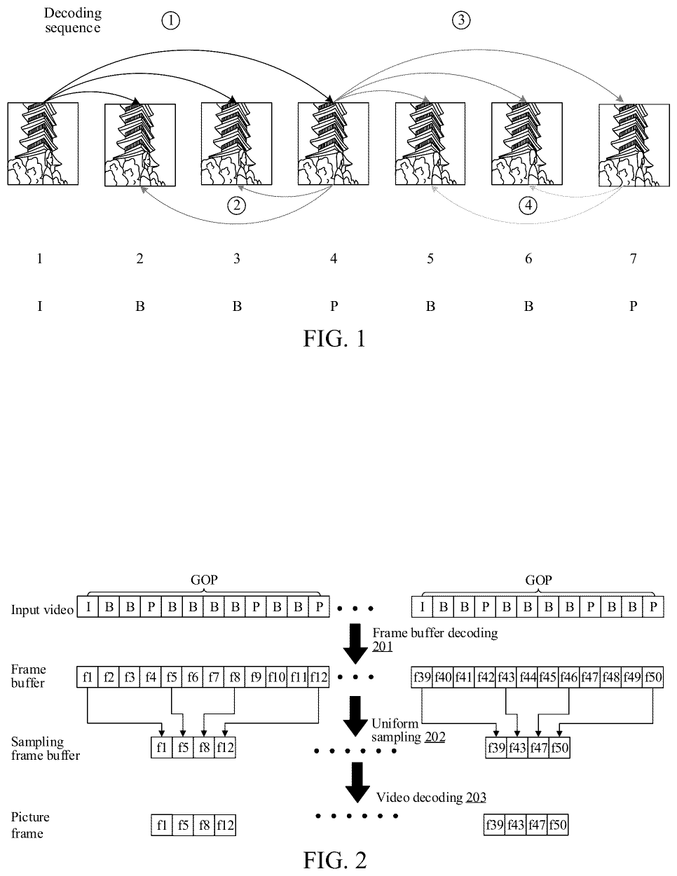

In a related art, a video decoding process is implemented by using a uniform frame capture algorithm, which may be divided into two operations: In the first operation, rendering data stored in a frame buffer of each video frame is decoded from a video stream. In the second operation, the rendering data stored in the frame buffer is rendered as a complete image. In the first operation, decoding of different video frames depends on different associated frames. As shown in FIG. 1, FIG. 1 is a schematic diagram of a frame decoding sequence in a related art. It may be learned that a fourth frame (P frame) can be decoded only after decoding of a first key frame (I frame) is completed. Because a second frame and a third frame are bi-directionally predicted code frames (B frames), decoding can be performed only after decoding of the first frame and the fourth frame in front of the B frames are completed. A decoding sequence in video decoding may be different from a picture sequence of video playback. When the rendering data in the frame buffer is decoded, information about each video frame, such as a time stamp and a size, may be further obtained.

FIG. 2 is a schematic flowchart of a video decoding method in a related art. As shown in FIG. 2, for an input video (including multiple video frames, for example, an I frame, a P frame, and a B frame in FIG. 2), frame buffer decoding 201 is first performed on each video frame from a video stream to obtain rendering data in a corresponding frame buffer, and the rendering data is stored in a cache. Then, a time stamp index of a video frame is calculated by uniform sampling 202, and rendering data in a corresponding frame buffer is extracted according to the time stamp index to perform video decoding 203.

The concept of GOP is not considered in the decoding process of the uniform frame capture algorithm in the related art. The “same” method is used for all video frames, and the following flaws exist in the process: First, in the decoding process of the rendering data in the frame buffer, all the video frames may be decoded, resulting in a slow decoding speed. Second, because importance of a key frame is not considered, a frame is missed, for example, a short video frame whose picture changes greatly. In addition, because redundancy between non-key frames is ignored, video frame pictures captured in a long segment of video (for example, duration of a video segment is greater than a preset duration threshold) are prone to be similar.

Based on the foregoing at least one problem in the related art, some embodiments provide a video decoding method, so as to ensure that a video frame whose picture changes greatly (for example, a video similarity between two adjacent video frames is less than a similarity threshold) is decoded by preferentially capturing a key frame, thereby reducing missing of a key frame in a to-be-decoded video. In addition, a B frame in the to-be-decoded video is removed to reduce inter-frame redundancy and accelerate the decoding process. As shown in FIG. 3, FIG. 3 is a diagram of a decoding comparison effect between some embodiments and a method in a related art. According to the video decoding method in some embodiments, it can be ensured that a video frame whose picture changes greatly is decoded, thereby reducing missing of a key frame, improving accuracy of video frame capturing, and further improving video decoding accuracy.

In the video decoding method provided in some embodiments, first, video stream analysis is performed on a to-be-decoded video to obtain a frame data packet of each video frame in the to-be-decoded video; the video stream analysis referring to parsing an encapsulated data packet that encapsulates video frame information in the to-be-decoded video; then determining a frame type of each video frame based on frame attribute information in the frame data packet; the frame type including a key frame and a non-key frame; determining multiple target sampling frames from the to-be-decoded video based on a quantity of key frames; the target sampling frames being video frames configured for providing rendering data when rendering the to-be-decoded video, and the rendering data being stored in frame buffers respectively corresponding to the target sampling frames; finally obtaining corresponding rendering data from a frame buffer of each of the target sampling frames; and performing video decoding on the to-be-decoded video based on the rendering data to obtain a decoded video corresponding to the to-be-decoded video. In this way, multiple target sampling frames are selected from all video frames. The target sampling frames are selected based on a quantity of key frames. Therefore, key frames may be preferentially extracted, and some non-key frames are removed from all the video frames, so that similar redundant frames can be reduced, and a video decoding process can be accelerated. In addition, video decoding is performed based on all key frames or based on all key frames and some non-key frames, and the key frame is a frame in which a picture changes greatly or a key action in a motion change of a role or an object is located, for example, the key frame is equivalent to a key drawing in a two-dimensional animation. When video decoding is performed on a to-be-decoded video based on rendering data stored in frame buffers of a large quantity of key frames, video decoding accuracy can be greatly improved.

Herein, an exemplary application of a video decoding device in some embodiments is first described, and the video decoding device is an electronic device configured to implement a video decoding method. In some embodiments, the video decoding device (for example, the electronic device) provided in some embodiments may be implemented as a terminal, or may be implemented as a server. In some embodiments, the video decoding device provided in some embodiments may be implemented as any terminal that has a video data processing function, such as a notebook computer, a tablet computer, a desktop computer, a mobile phone, a portable music player, a personal digital assistant, a dedicated message device, a portable game device, an intelligent robot, an intelligent household electrical appliance, and an intelligent in-vehicle device. In some embodiments, the video decoding device provided in some embodiments may be further implemented as a server. The server may be an independent physical server, or may be a server cluster or a distributed system formed by multiple physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. The terminal and the server may be directly or indirectly connected in a wired or wireless communication manner, which is not limited. The following describes an exemplary application when the video decoding device is implemented as a server.

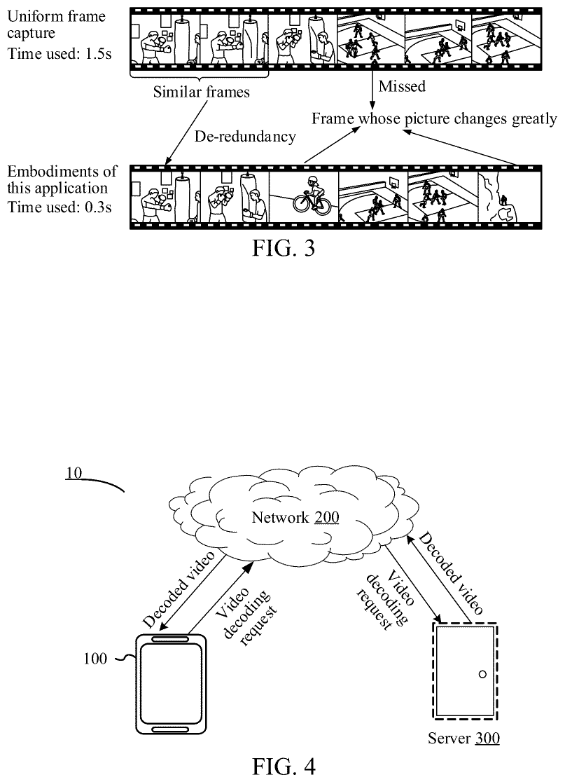

Referring to FIG. 4, FIG. 4 is an optional schematic architectural diagram of a video decoding system according to some embodiments. In some embodiments, an example in which a video decoding method is applied to any video application is used for description. In a video application, a video recognition function is provided, and the video recognition function may be implemented after video decoding is performed on a to-be-decoded video inputted by a user, to obtain a video recognition result, so as to perform a subsequent processing operation based on the video recognition result. In some embodiments, the video decoding system includes at least a terminal 100, a network 200, and a server 300. The server 300 may be a server of the video application. The server 300 may constitute the video decoding device in some embodiments. The terminal 100 is connected to the server 300 by using the network 200. The network 200 may be a wide area network, a local area network, or a combination thereof.

In some embodiments, when performing video decoding, the terminal 100 receives the to-be-decoded video of the user by using a client of the video application. The to-be-decoded video is encapsulated into a video decoding request, and the terminal 100 sends the video decoding request to the server 300 by using the network 200. After receiving the video decoding request, the server 300 performs video stream analysis on the to-be-decoded video in response to the video decoding request, to obtain a frame data packet of each video frame in the to-be-decoded video. The video stream analysis herein refers to parsing an encapsulated data packet that encapsulates video frame information in the to-be-decoded video. Then, a frame type of each video frame is determined based on frame attribute information in the frame data packet. The frame type includes a key frame and a non-key frame. Then, multiple target sampling frames are determined from the to-be-decoded video based on a quantity of key frames. The target sampling frames are video frames configured for providing rendering data when rendering the to-be-decoded video, and the rendering data is stored in frame buffers respectively corresponding to the target sampling frames. Finally, corresponding rendering data is obtained from a frame buffer of each of the target sampling frames. Video decoding is performed on the to-be-decoded video based on the rendering data, to obtain a decoded video corresponding to the to-be-decoded video. After obtaining the decoded video, the server 300 may send the decoded video to the terminal 100, so as to display the decoded video on a current interface of the terminal 100.

In some embodiments, after obtaining the decoded video, the server 300 may further perform video recognition on the decoded video to obtain a video recognition result, and send the video recognition result to the terminal 100, so as to perform a subsequent operation on the terminal 100 based on the video recognition result. An application scenario of the decoded video is described below by using an example.

In some embodiments, the video decoding device may be implemented as a terminal, for example, the terminal 100 is used as an execution body to implement the video decoding method in some embodiments. In some embodiments, the terminal 100 collects a to-be-decoded video by using the client of the video application. In addition, the terminal 100 performs video stream analysis on the to-be-decoded video to obtain a frame data packet of each video frame in the to-be-decoded video. Then, the terminal 100 determines a frame type of each video frame based on the frame attribute information in the frame data packet. The frame type includes a key frame and a non-key frame. Then, the terminal 100 determines multiple target sampling frames from the to-be-decoded video based on a quantity of key frames. Finally, the terminal 100 obtains corresponding rendering data from a frame buffer of each of the target sampling frames; and performs video decoding on the to-be-decoded video based on the rendering data to obtain a decoded video corresponding to the to-be-decoded video.

The video decoding method provided in some embodiments may be implemented based on a cloud platform and by using a cloud technology. For example, the server 300 may be a cloud server. Video stream analysis is performed on a to-be-decoded video by using the cloud server, or a frame type of each video frame is determined by using the cloud server, or a target sampling frame is determined from the to-be-decoded video by using the cloud server, or video decoding is performed on the to-be-decoded video by using the cloud server.

In some embodiments, there may be further a cloud memory, and information such as a to-be-decoded video, a frame type of each video frame, and rendering data in a frame buffer of each video frame may be stored in the cloud memory, or a decoded video may be stored in the cloud memory. In this way, when video recognition is performed on the to-be-decoded video, the decoded video may be obtained from the cloud memory, and video recognition is performed based on the decoded video, thereby improving video recognition efficiency.

The cloud technology is a hosting technology that unifies a series of resources, such as hardware, software, and a network, in a wide region network or a local region network, to implement computing, storage, processing, and sharing of data. A cloud technology is a term of a network technology, an information technology, an integration technology, a management platform technology, and an application technology that are applied based on a cloud computing business model. The cloud technology may form a resource pool and be used, and is flexible and convenient. The cloud computing technology will become an important support. A background service of a technology network system may use a large amount of computing and storage resources, such as a video website, a picture website, and more portals. With rapid development and application of the Internet industry, each item may have its own identification mark in the future. The identification mark may be transmitted to a background system for logical processing. Data at different levels will be processed separately. All types of industry data may be supported by a powerful system, which may be implemented through cloud computing.

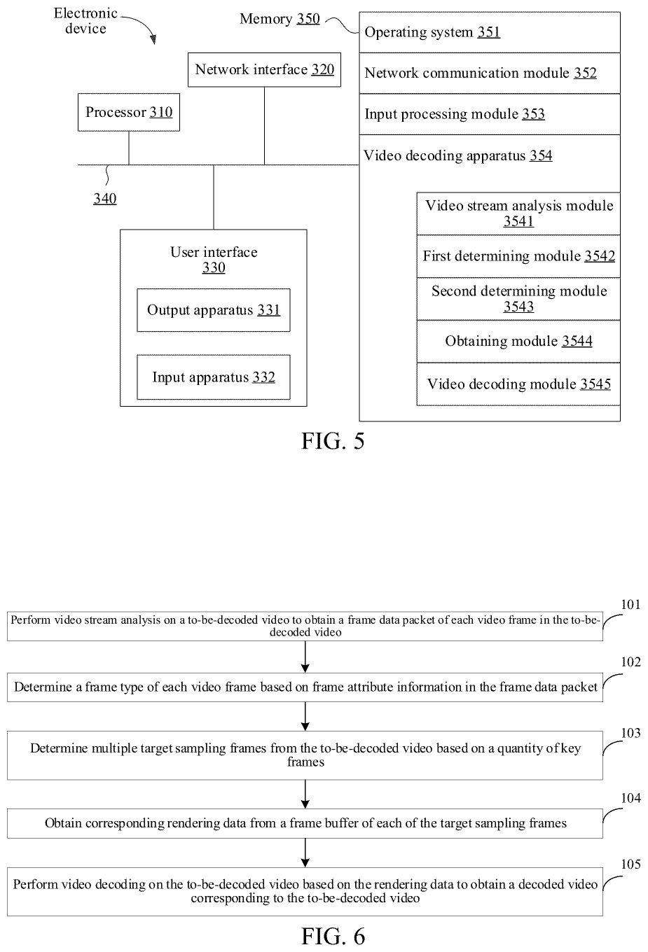

FIG. 5 is a schematic structural diagram of an electronic device according to some embodiments. The electronic device shown in FIG. 5 may be a video decoding device, and the video decoding device includes: at least one processor 310, a memory 350, at least one network interface 320, and a user interface 330. Components in the video decoding device are coupled together by using a bus system 340. The bus system 340 is configured to implement connection and communication between the components. In addition to a data bus, the bus system 340 further includes a power bus, a control bus, and a status signal bus. However, for clear description, all types of buses in FIG. 5 are marked as the bus system 340.

The processor 310 may be an integrated circuit chip, and has a signal processing capability, for example, a central processing unit (CPU), a digital signal processor (DSP), another programmable logic device, a discrete gate or transistor logic device, or a discrete hardware component. The CPU may be a microprocessor or any processor.

The user interface 330 includes one or more output apparatuses 331 that can present media content, and one or more input apparatuses 332.

The memory 350 may be removable, non-removable, or a combination thereof. An exemplary hardware device includes a solid-state memory, a hard disk drive, an optical disk drive, and the like. In some embodiments, the memory 350 includes one or more storage devices physically located away from the processor 310. The memory 350 includes a volatile memory or a non-volatile memory, or may include both a volatile memory and a non-volatile memory. The non-volatile memory may be a read-only memory (ROM), and the volatile memory may be a random access memory (RAM). The memory 350 described in some embodiments is intended to include various types of memory. In some embodiments, the memory 350 can store data to support various operations, and examples of the data include programs, modules, and data structures, or subsets or supersets thereof, as illustrated below.

An operating system 351 includes system programs used for processing various system services and executing hardware-related tasks, such as a framework layer, a kernel library layer, and a driver layer, and is used for implementing various services and processing hardware-based tasks. A network communication module 352 is configured to reach another computing device through one or more (wired or wireless) network interfaces 320. An example of the network interface 320 includes: Bluetooth, wireless compatibility authentication (Wi-Fi), universal serial bus (USB), and the like. An input processing module 353 is configured to detect one or more user inputs or interactions from one of one or more input devices 332 and translate a detected input or interaction.

In some embodiments, the apparatus provided in some embodiments may be implemented in a software manner. FIG. 5 shows a video decoding apparatus 354 stored in a memory 350. The video decoding apparatus 354 may be a video decoding apparatus in an electronic device, and may be software in a form of a program, a plug-in, or the like, and includes the following software modules: a video stream analysis module 3541, a first determining module 3542, a second determining module 3543, an obtaining module 3544, and a video decoding module 3545. These modules are logical modules. Any combination or further division may be performed according to an implemented function. Functions of the modules are described below.

In some embodiments, the apparatus provided in some embodiments may be implemented in a hardware manner. As an example, the apparatus provided in some embodiments may be a processor in the form of a hardware decoding processor. The processor is programmed to perform the video decoding method provided in some embodiments. For example, the processor in the form of a hardware decoding processor may use one or more application-specific integrated circuits (ASIC), DSPs, programmable logic devices (PLD), complex programmable logic devices (CPLD), field-programmable gate arrays (FPGA), or other electronic elements.

The video decoding method according to some embodiments may be performed by an electronic device. The electronic device may be a server or a terminal. For example, the video decoding method in some embodiments may be performed by a server, may be performed by a terminal, or may be performed through interaction between the server and the terminal.

FIG. 6 is an optional schematic flowchart of a video decoding method according to some embodiments. The following describes the video decoding method with reference to operations shown in FIG. 6. The video decoding method in FIG. 6 is described by using an example in which a server is used as an execution body. As shown in FIG. 6, the method includes the following operations 101 to 105:

Operation 101: Perform video stream analysis on a to-be-decoded video to obtain a frame data packet of each video frame in the to-be-decoded video.

Herein, the to-be-decoded video may be a video played by a user on a video application, a video downloaded by the user by using a video application, or a video shot by the user. The video decoding method in some embodiments may be applied to video recognition, for example, a decoded video may be obtained after decoding is performed on the to-be-decoded video, so as to recognize information such as video content and a video type based on the decoded video. In some embodiments scenario, the to-be-decoded video may be a to-be-recognized video. The user may request to recognize the to-be-recognized video by using a video application. Before the to-be-recognized video is recognized, the to-be-recognized video is first used as a to-be-decoded video, and the video decoding method provided in some embodiments is used to perform video decoding.

Video stream analysis is to parse an encapsulated data packet that encapsulates video frame information in the to-be-decoded video, so as to obtain a frame data package of each video frame in the to-be-decoded video. Herein, the to-be-decoded video is considered as being parsed in a form of a video stream. The video stream of the to-be-decoded video mentioned in some embodiments is stream data compressed by using a compression algorithm, or may be referred to as a coded stream. For example, when a compression/coding algorithm of H264 is configured for encoding the video, the video stream of the to-be-decoded video may be referred to as a H264 code stream.

In some embodiments, for the to-be-decoded video, video frame information of each video frame in the to-be-decoded video may be encapsulated into a respective frame data packet in advance. To facilitate understanding of subsequent content, the video frame is described herein. A video frame is an element of a video stream. For video coding/compression, the core is to store a group of consecutive frame data in time by minimizing space used. Video decoding is to restore a group of coded/compressed frame data. A coding/compression algorithm that can be restored by 100% is referred to as lossless compression, and on the contrary, is referred to lossy compression (although lossless compression is ideal, lossy compression often has to be selected in many practical scenarios to pursue a high compression rate, for example, to reduce network bandwidth pressure). It can be learned that the video frame (or may be referred to as a frame for short) is the core of the video stream media field. The video frame may be understood as a frame of image that is normally seen. Differently, the image is in an RGB format, and the video frame is in a YUV format. Video frame information refers to data of a corresponding video frame in a YUV format. An image that can be presented by the video frame is obtained by decoding the video frame information of the video frame. For example, the video frame information provides all information configured for decoding and rendering a corresponding video frame image.

A frame data packet includes not only content for decoding the video frame, but also information such as a frame type of the video frame. For example, video frame information of each video frame includes not only data in the foregoing YUV format, but also information such as a frame type of the video frame. The frame type may be stored in the frame data packet in a form of frame attribute information. All video frames of a to-be-decoded video may include the following frame types: a key frame and a non-key frame. A frame data packet of the key frame includes complete information of this frame of picture, for example, includes all content of the present frame of data. This frame of picture is completely reserved in the frame data packet of the key frame. The present frame of picture may complete decoding (because a complete picture is included). A frame data packet of the non-key frame includes difference information between this frame of picture and a video frame before the present frame or between this frame of picture and video frames before and after the present frame. For example, for the non-key frame, the difference information defined in the present frame may be superposed on a previously buffered picture during decoding, so that a final picture can be generated.

Operation 102: Determine a frame type of each video frame based on frame attribute information in the frame data packet.

Herein, the frame type includes a key frame and a non-key frame.

The key frame is an image frame in which all content of this frame of picture (for example, the present frame of picture) is reserved (in which the present frame of picture is obtained by performing image rendering on rendering data of the present frame), and a final picture can be generated by coding data of the present frame without reference to another image frame. The to-be-decoded video may include one or more or all of three code frames: An intra-coded image frame (I frame, Intra-coded Frame), a predictive-coded image frame (P frame, Predictive-coded Frame), and a bi-directionally predicted code image frame (B frame, Bi-directionally Predicted Frame). The key frame may be an I frame, and the I frame completely reserves all content of the present frame of picture. Therefore, during coding of the I frame, another image frame of the to-be-encoded video may be not referenced, and only information about the I frame itself is used for coding. During decoding of the I frame, decoding can be completed only by using coded present frame of data. For the to-be-decoded video, one GOP is one group of consecutive pictures, and one video includes multiple GOPs. The key frame may be a key frame in the GOP, and is a complete picture. When a picture changes greatly, an I frame may be re-coded. In the computer animation field, the key frame may include a frame in which a key action in a motion change of a role or an object is located, which is equivalent to a key drawing in a two-dimensional animation. An animation between key frames may be created and added by software, and may be referred to as a transition frame or an intermediate frame. The frame herein is a single image picture of a smallest unit in an animation, and is equivalent to each frame on a strip of film in a movie. On a time axis of animation software, a frame is represented as a grid or a mark. Both the frame and the video frame in some embodiments represent a single image picture of a smallest unit in the to-be-decoded video.

The non-key frame is an image frame in which difference data (for example, rendering data that is differentiated from that of a previous image frame, not including same rendering data) between this image frame and a previous image frame in an image frame sequence (for example, a video frame sequence formed by multiple video frames of the to-be-decoded video) is stored, or is an image frame in which difference data between this image frame and two image frames before and after this image frame is stored. For example, the non-key frame does not completely reserve all content of this frame of picture (for example, the present frame of picture), so that a final picture can be generated only by superposing a previously buffered picture on a difference defined by a difference frame before or after the present frame. During decoding of the non-key frame, it is necessary to use information about the non-key frame itself with reference to information about another picture frame, to complete decoding and generate an image frame of the final picture. The non-key frames may be a P frame and/or a B frame. The non-key frame includes a forward difference frame and a bi-directional difference frame, the forward difference frame may be a P frame, and the bi-directional difference frame may be a B frame. The P frame represents a difference between a current frame and a previous key frame (or a P frame). The P frame uses a previous I frame or P frame to perform inter-frame prediction coding in a motion prediction manner. During decoding of the P frame, a difference defined by the present frame may be superposed on a previously buffered picture to generate a final picture (for example, the P frame is a difference frame, and the P frame has no complete picture data, and has only data that is differentiated from a picture of a previous frame). The B frame is a bi-directional difference frame, For example, the B frame records differences between the present frame and frames before and after it. The B frame can provide the highest compression ratio. During decoding, the frames before and after the B frame are depended, for example, not only a previously buffered picture should be obtained, but also a later picture may be decoded, and a final picture is obtained by superposing the pictures before and after the B frame on the present frame of data. A first frame of the GOP is definitely an I frame.

In some embodiments, the frame data packet includes not only content for decoding the video frame, but also the information such as the frame type of the video frame, and the frame type is stored in the frame data packet as the frame attribute information. After the frame data packet of each video frame is obtained, the frame type of each video frame may be determined based on the frame attribute information in the frame data packet.

Operation 103: Determine multiple target sampling frames from the to-be-decoded video based on a quantity of key frames.

Herein, the target sampling frames are video frames configured for providing rendering data when rendering the to-be-decoded video, and the rendering data is stored in frame buffers respectively corresponding to the target sampling frames.

In some embodiments, a quantity of target sampling frames is less than a total quantity of video frames in the to-be-decoded video. After the frame type of each video frame is determined, the quantity of key frames and a quantity of non-key frames may be separately counted, and the target sampling frames are further determined from the key frames and the non-key frames based on the quantity of key frames. The target sampling frames are video frames configured for providing rendering data when rendering the to-be-decoded video.

In some embodiments, the quantity of target sampling frames is less than the total quantity of video frames in the to-be-decoded video, For example, target sampling frames having the quantity are selected from all the video frames, and some non-key frames are excluded.

In some embodiments, when the quantity of key frames is greater than the quantity of target sampling frames, all target sampling frames may be directly determined from the key frames. When the quantity of key frames is less than the quantity of target sampling frames, all key frames may be determined as target sampling frames. In addition, a part of target sampling frames further may be determined from the non-key frames. When the quantity of key frames is equal to the quantity of target sampling frames, all key frames may be determined as target sampling frames.

In some embodiments, the quantity of target sampling frames may be determined according to an application scenario type of the to-be-decoded video, or determined according to video duration of the to-be-decoded video. The following describes a process of determining the quantity of target sampling frames.

In some embodiments, each video frame is corresponding to one frame buffer. The frame buffer is inherently a space in a memory or hardware, and is responsible for storing pixel-related information of an image that may be rendered. For example, the frame buffer stores rendering data of a corresponding video frame, and the rendering data is pixel-related information of the corresponding video frame. Herein, the pixel-related information includes but is not limited to one or more of the following: a color buffer, a depth buffer (Z buffer), and a module buffer (Stencil buffer), where the color buffer is configured for recording pixel color information; the depth buffer is configured for recording a pixel depth value; and the module buffer is configured for defining a rendering region, and can create different rendering effects together with the depth buffer.

The target sampling frame may be a key frame, or may be a non-key frame.

For a key frame, rendering data stored in a frame buffer is data configured for rendering a complete picture of the key frame, for example, all content for rendering the present frame of picture is completely reserved in the frame buffer of the key frame, and the rendering data stored in the frame buffer of the key frame is all rendering data of the key frame. For a non-key frame, rendering data stored in a frame buffer of the non-key frame is a part of rendering data for rendering the non-key frame, where the rendering data stored in the frame buffer is difference data between the non-key frame and a video frame previous to the non-key frame in an image frame sequence, and the rendering data stored in the frame buffer of the non-key frame is configured for defining a difference between the non-key frame and the previous video frame. For a non-key frame, rendering data stored in a frame buffer may be difference data between the non-key frame and two video frames before and after the video frame in an image frame sequence, and the rendering data stored in the frame buffer of the non-key frame is configured for defining differences between the non-key frame and the two video frames before and after the non-key frame.

For a key frame, when image rendering is performed, rendering data of the key frame may be obtained from a frame buffer of the key frame, and image rendering is performed on the rendering data to obtain a complete picture of the key frame, for example, a video picture corresponding to the key frame may be obtained through rendering. For a non-key frame, when image rendering is performed, rendering data (which may be referred to as difference rendering data) of the non-key frame may be obtained from a frame buffer of the non-key frame, rendering data of one video frame before the non-key frame is obtained, then the difference rendering data is fused with the rendering data of the video frame before the non-key frame (for example, corresponding data in the rendering data of the video frame before the non-key frame is replaced with the difference rendering data) to obtain final rendering data that can be used for rendering the non-key frame, and image rendering is performed on the final rendering data to obtain a complete picture of the non-key frame, for example, a video picture corresponding to the non-key frame may be obtained through rendering. For a non-key frame, when image rendering is performed, rendering data (which may be referred to as difference rendering data) of the non-key frame may be obtained from a frame buffer of the non-key frame, rendering data of two video frames before and after the non-key frame is obtained, then the difference rendering data is fused with the rendering data of the two video frames before and after the non-key frame (for example, corresponding data in the rendering data of the two video frames before and after the non-key frame are replaced with the difference rendering data) to obtain final rendering data that can be used for rendering the non-key frame, and image rendering is performed on the final rendering data to obtain a complete picture of the non-key frame, for example, a video picture corresponding to the non-key frame may be obtained through rendering.

Operation 104: Obtain corresponding rendering data from a frame buffer of each of the target sampling frames.

Herein, the frame buffer of each target sampling frame may be first determined. The frame buffer includes information for decoding the video frame. For example, the frame buffer is buffer data configured for providing information for image rendering when image rendering is performed on the to-be-decoded video, the buffer data may include decoding information for decoding the video frame, and the decoding information is defined as information for decoding a corresponding video frame. Information for decoding a corresponding video frame may be referred to as rendering data of the corresponding video frame, and a video picture of the corresponding video frame can be rendered by using the rendering data.

In some embodiments, all video frames of the to-be-decoded video form a video frame sequence. In the video frame sequence, all the video frames are sequentially arranged according to the sequential order of the video frames in the to-be-decoded video, and there is a frame buffer sequence corresponding to the video frame sequence. In the frame buffer sequence, data related to the frame buffer of each video frame is included, for example, a buffer identifier of the frame buffer, and the buffer identifier is configured for uniquely identifying an address of the corresponding frame buffer. In some embodiments, when target sampling frames having the quantity of target sampling frames are obtained, the target sampling frames may be reassembled into a sampling frame sequence according to the sequential order thereof in the video frame sequence. In addition, a frame index corresponding to each target sampling frame in the video frame sequence may be further obtained. Correspondingly, a frame index sequence corresponding to the sampling frame sequence may also be generated according to the sequential order of the target sampling frames in the video frame sequence. When the frame buffer is obtained, the frame buffer of the target sampling frame corresponding to each frame index may be successively obtained from the frame buffer sequence based on the frame index sequence.

Operation 105: Perform video decoding on the to-be-decoded video based on the rendering data to obtain a decoded video corresponding to the to-be-decoded video.

In some embodiments, after the rendering data stored in the frame buffer of each target sampling frame in the sampling frame sequence is obtained, a corresponding video frame may be rendered based on the rendering data of each target sampling frame, so as to implement video decoding on the to-be-decoded video, to obtain multiple decoded image frames, and form a final decoded video by using the multiple decoded image frames.

Herein, video decoding refers to a process in which rendering data in a frame buffer of a target sampling frame is read, and the rendering data is decoded to obtain a decoded image frame configured for presenting an image of the target sampling frame, for example, image rendering is performed on the rendering data to obtain the decoded image frame. Video decoding may be understood as a process of performing image rendering on rendering data in a frame buffer of a target sampling frame. For example, in some embodiments, video decoding based on rendering data in a frame buffer of a target sampling frame may be performed by first extracting buffer data (for example, rendering data) that is configured for providing information for image rendering when image rendering is performed on the target sampling frame, and then rendering the extracted buffer data into an image frame to obtain the decoded video frame. For example, image rendering is performed based on the buffer data of the target sampling frame, to obtain a frame of decoded image frame corresponding to the to-be-decoded video. After decoded image frames of all the target sampling frames are obtained, multiple decoded image frames are concatenated into the decoded video according to the sequential order of the target sampling frames in the to-be-decoded video.

In some embodiments, a decoded image frame sequence corresponding to a sampling frame sequence may be obtained by obtaining each decoded image frame, and the decoded image frame sequence includes a decoded image frame corresponding to each target sampling frame in the sampling frame sequence. The decoded video is obtained by performing video visualization processing on the decoded image frame sequence, for example, the decoded image frames in the decoded image frame sequence are concatenated into the decoded video in a video form according to the sequential order in the decoded image frame sequence.

In some embodiments, a quantity of video frames included in the obtained decoded video is far less than a quantity of video frames corresponding to the original to-be-decoded video, and the decoded video includes key frames in the to-be-decoded video. Information in the to-be-decoded video can be completely reserved. In this way, in an application field such as video recognition, after video decoding is first performed on a to-be-recognized video by using the video decoding method provided in some embodiments, a decoded video is obtained, so that recognition is performed on the decoded video, and video recognition efficiency can be greatly improved.

According to the video decoding method provided in some embodiments, a frame type of each video frame is determined based on frame attribute information in a frame data packet of each video frame in a to-be-decoded video. The frame type includes a key frame and a non-key frame. Then, target sampling frames are determined from key frames and non-key frames based on a quantity of key frames. A quantity of target sampling frames is less than a total quantity of video frames in the to-be-decoded video. Rendering data stored in a frame buffer of each target sampling frame is obtained. Video decoding is performed on the to-be-decoded video based on the rendering data in the frame buffer of the target sampling frame, to obtain a decoded video corresponding to the to-be-decoded video. In this way, the quantity of target sampling frames is less than the total quantity of video frames in the to-be-decoded video, for example, target sampling frames are selected from all video frames, key frames are preferentially extracted, and some non-key frames are excluded, so that similar redundant frames can be reduced, a video decoding process can be accelerated, and video decoding accuracy can be improved.

In some embodiments, the video decoding system includes at least a terminal and a server, and a video application is installed on the terminal. When the user requests to decode the to-be-decoded video in the video application, the method in some embodiments may be used, and video recognition may be further performed on the decoded video.

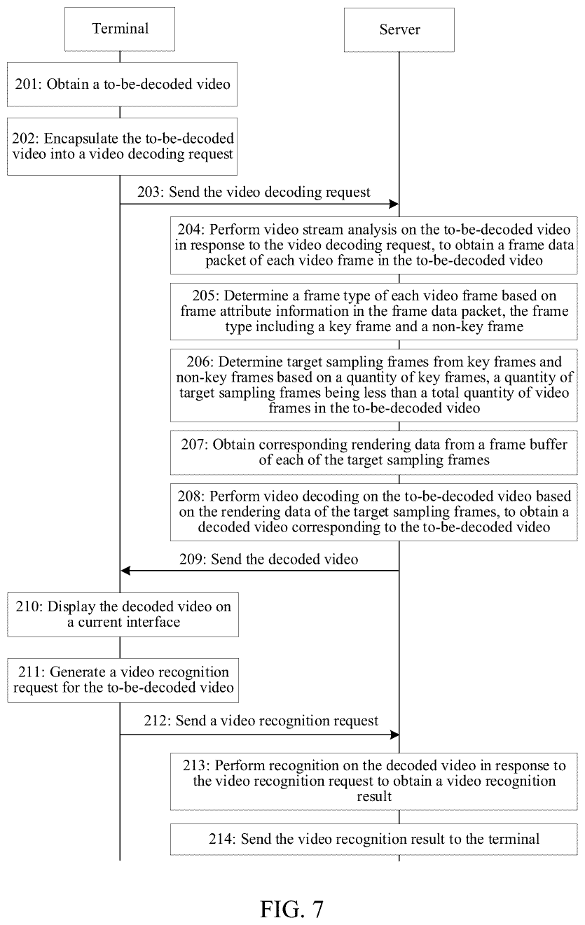

FIG. 7 is another optional schematic flowchart of a video decoding method according to some embodiments. The video decoding method may be applied to a video processing process, for example, a video is decoded before video processing, and corresponding video processing is performed based on a decoded video. As shown in FIG. 7, the method includes the following operations 201 to 214:

Operation 201: A terminal obtains a to-be-decoded video.

Herein, the to-be-decoded video may be any type of video, for example, a long video, a short video, a video released on a website, a television play video, a movie video, or a video generated by using video production software.

The terminal may obtain the to-be-decoded video by using a video application. For example, the to-be-decoded video may be a video in the video application, or a video downloaded by the video application from another platform, or a video uploaded by a user by using a client of the video application. In the video application, a video processing function may be provided. The video processing function herein includes but is not limited to functions such as video type recognition and video content recognition. A user may select any video on the client of the video application, and taps a trigger button of the video processing function, so as to trigger a video processing operation of the video (for example, the to-be-decoded video). When video processing is performed, video decoding may be first performed on the video, and then corresponding video processing is performed after video decoding is completed.

Operation 202: The terminal encapsulates the to-be-decoded video into a video decoding request.

In some embodiments, after the to-be-decoded video is obtained, the to-be-decoded video is encapsulated to form the video decoding request. In some embodiments, the to-be-decoded video may be encapsulated into the video processing request (for example, the video processing request herein may be a video recognition request), so that after receiving the video processing request, a server first decodes the to-be-decoded video in response to the video processing request and then performs related video processing on the to-be-decoded video. For example, when the video decoding request is sent to the server, the server performs video decoding processing. When the video processing request is sent to the server, the server performs video decoding processing and related video processing.

Operation 203: The terminal sends the video decoding request to the server.

Operation 204: The server performs video stream analysis on the to-be-decoded video in response to the video decoding request, to obtain a frame data packet of each video frame in the to-be-decoded video.

Herein, video stream analysis is to parse an encapsulated data packet that encapsulates video frame information in the to-be-decoded video, so as to obtain a frame data package of each video frame in the to-be-decoded video. In some embodiments, for the to-be-decoded video, video frame information of each video frame may be encapsulated into a respective frame data packet in advance. The frame data packet includes not only content for decoding the video frame, but also information such as a frame type of the video frame. The frame type may be stored in the frame data packet in a form of frame attribute information.

Operation 205: The server determines a frame type of each video frame based on frame attribute information in the frame data packet. The frame type includes a key frame and a non-key frame.

In some embodiments, the frame type of each video frame may be determined in the following manner: First, the frame attribute information in the frame data packet is obtained, and the frame attribute information includes the frame type of the corresponding video frame. Then, the frame attribute information is parsed to obtain the frame type of the video frame corresponding to the frame data packet.

In some embodiments, the frame data packet includes not only content for decoding the video frame, but also the information such as the frame type of the video frame, and the frame type is stored in the frame data packet as the frame attribute information. After the frame data packet of each video frame is obtained, the frame attribute information in each frame data packet may be first obtained, and it is determined, according to the frame attribute information, whether the frame type of the video frame is a key frame or a non-key frame.

For example, the frame data packet records the video frame is which one of three code frames: an I frame, a P frame, and a B frame. After the frame attribute information of each frame data packet is obtained, a corresponding video frame may be determined based on the frame attribute information as which one of three code frames: an I frame, a P frame, and a B frame.

Operation 206: The server determines target sampling frames from key frames and non-key frames based on a quantity of key frames. A quantity of target sampling frames is less than a total quantity of video frames in the to-be-decoded video.

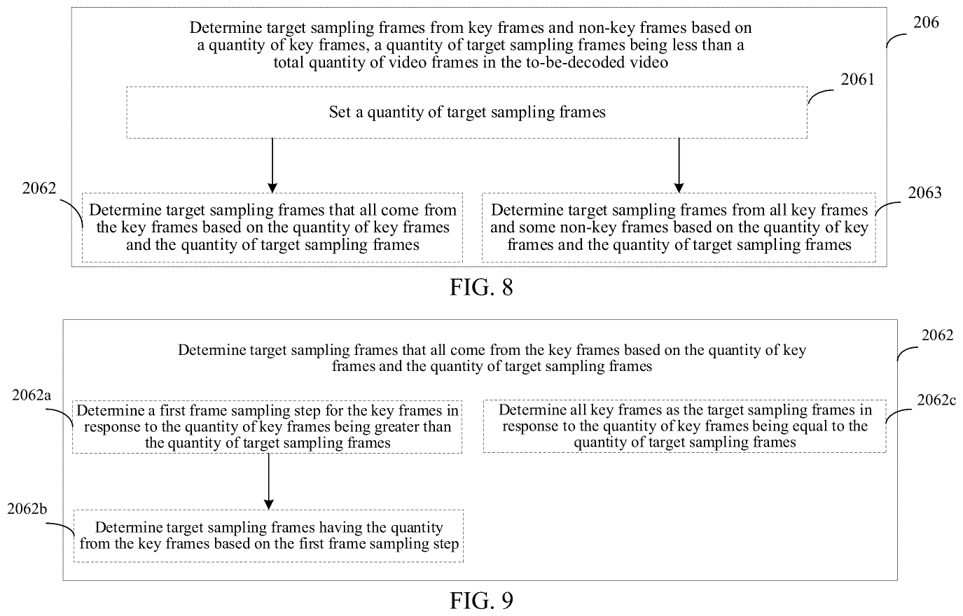

In some embodiments, referring to FIG. 8, FIG. 8 shows that operation 206 may be implemented by using the following operations 2061 to 2063:

Operation 2061: Set the quantity of target sampling frames.

In some embodiments, the quantity of target sampling frames may be set in any of the following manners.

Manner 1: determining an application scenario type of a decoded video, and determining the quantity of target sampling frames based on the application scenario type. For example, if a decoded video obtained after the to-be-decoded video is decoded is configured for performing video type recognition, a first sampling frame quantity may be set. If the decoded video obtained after the to-be-decoded video is decoded is configured for performing video content analysis, another second sampling frame quantity may be set. The second sampling frame quantity may be greater than the first sampling frame quantity, so that it can be ensured that the decoded video includes a relatively large quantity of target sampling frames, and video content in the to-be-decoded video is accurately analyzed.

For another example, if the to-be-decoded video is a content-rich video generated by the user by using software, a relatively large quantity of target sampling frames (for example, the quantity of target sampling frames may be greater than a quantity threshold) may be set when video recognition is performed on the to-be-decoded video, thereby ensuring that a final recognition result is more accurate.

In some embodiments, the quantity of target sampling frames may be set to a fixed value in advance, and target sampling frames having the quantity are obtained through sampling for different to-be-decoded videos.

Manner 2: determining the quantity of target sampling frames based on video duration of the to-be-decoded video.

Herein, for a to-be-decoded video with relatively long video duration (for example, the video duration is greater than a duration threshold), a relatively large quantity of target sampling frames (for example, the quantity of target sampling frames may be greater than a quantity threshold) may be set. In this way, it can be ensured that more target sampling frames are obtained for a to-be-decoded video with relatively long video duration and a relatively large amount of content, and more sampling is performed for key frames in the to-be-decoded video, thereby increasing an amount of information included in a finally generated decoded video, and further improving recognition accuracy of the decoded video in a further video recognition process.

In some embodiments, when the video duration is less than or equal to the duration threshold, it may be determined that the quantity of target sampling frames is a third sampling frame quantity. When the video duration is greater than the duration threshold, it is determined that the quantity of target sampling frames is a fourth sampling frame quantity. The third sampling frame quantity is less than the fourth sampling frame quantity.

In some embodiments, multiple duration interval gradient ranges and a quantity corresponding to each duration interval gradient range may be preset to form a mapping relationship between duration interval gradient ranges and different quantities. In this way, after the video duration of the to-be-decoded video is obtained, a duration interval gradient range to which the video duration of the to-be-decoded video belongs may be determined, so as to determine a target duration interval gradient range. Then, based on the foregoing mapping relationship, a target sampling frame quantity corresponding to the target interval duration gradient range is determined, and the target sampling frame quantity is determined as the quantity of target sampling frames in some embodiments.

For example, multiple duration interval gradient ranges may be set: [0, 10 minutes], [10 minutes, 20 minutes], [20 minutes, 30 minutes], [30 minutes, 40 minutes], [40 minutes, 50 minutes], where [0, 10 minutes] is corresponding to a sampling frame quantity K (where K is an integer greater than 1), [10 minutes, 20 minutes] is corresponding to a sampling frame quantity 2K, [20 minutes, 30 minutes] is corresponding to a sampling frame quantity 3K, [30 minutes, 40 minutes] is corresponding to a sampling frame quantity 4K, and [40 minutes, and 50 minutes] is corresponding to a sampling frame quantity 5K. Assuming that the video duration of the to-be-decoded video is determined to be 38 minutes, the quantity of target sampling frames may be determined to be 4K.

Operation 2062: Determine target sampling frames that all come from the key frames based on the quantity of key frames and the quantity of target sampling frames.

In some embodiments, the quantity of key frames may be greater than or equal to the quantity of target sampling frames. Referring to FIG. 9, FIG. 9 shows that operation 2062 may be implemented by using the following operations 2062a to 2062c:

Operation 2062a: Determine a first frame sampling step for the key frames in response to the quantity of key frames being greater than the quantity of target sampling frames.

In some embodiments, the first frame sampling step for the key frames may be determined in the following manner: First, a first ratio between the quantity of key frames and the quantity of target sampling frames is determined. Then, rounding processing is performed on the first ratio to obtain the first frame sampling step. Herein, rounding processing refers to rounding a non-integer number by rounding off the number after the decimal point to make the number an integer, or directly deleting the data after the decimal point and reserving only the integer portion before the decimal point to form an integer value. In some embodiments, the first frame sampling step may be obtained by rounding the first ratio, or the decimal portion after the decimal point is removed from the first ratio, and the integer portion is reserved to form the first frame sampling step.

Operation 2062b: Determine target sampling frames having the quantity from the key frames based on the first frame sampling step.

In some embodiments, a key frame sequence may be formed for all key frames in the to-be-decoded video. In a sampling process, target sampling frames having this quantity may be obtained by performing sampling in the key frame sequence according to the first frame sampling step. The first key frame in the key frame sequence is a target sampling frame that may be sampled, and then one target sampling frame is obtained through sampling at an interval of the first frame sampling step.

For example, the key frame may be an I frame. When the quantity of key frames is less than the quantity of target sampling frames, for example, when a quantity of I frames is greater than a total quantity of frames to be sampled, some I frames may be sampled. When I frames are sampled, a uniform sampling manner may be used, for example, target sampling frames having this quantity are obtained through sampling by using the first frame sampling step from a frame sequence formed by multiple I frames.

Operation 2062c: Determine all key frames as the target sampling frames in response to the quantity of key frames being equal to the quantity of target sampling frames.

Herein, because the quantity of key frames is equal to the quantity of target sampling frames, all key frames may be directly sampled, for example, all the key frames are determined as the target sampling frames.

For example, the key frame may be an I frame. When the quantity of key frames is equal to the quantity of target sampling frames, for example, a quantity of I frames is equal to a total quantity of frames to be sampled, all I frames may be sampled to obtain the target sampling frames, for example, all the I frames are determined as the target sampling frames.

Operation 2063: Determine target sampling frames from all key frames and some non-key frames based on the quantity of key frames and the quantity of target sampling frames.

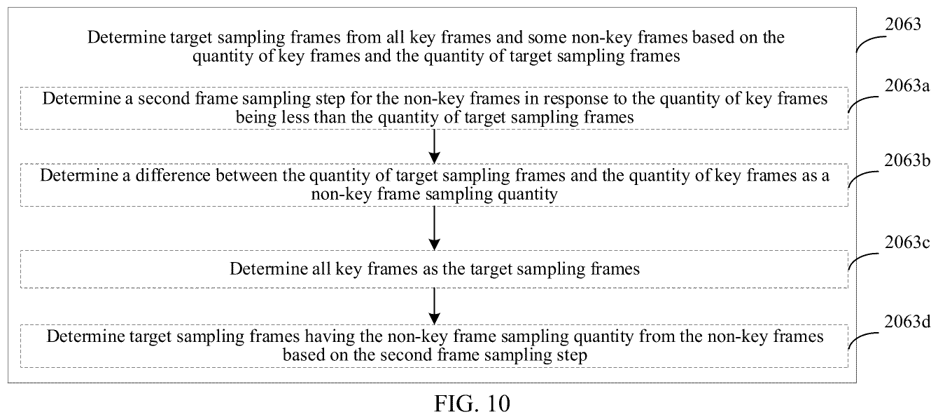

In some embodiments, the quantity of key frames may be less than the quantity of target sampling frames. Referring to FIG. 10, FIG. 10 shows that operation 2063 may be implemented by using the following operations 2063a to 2063d:

Operation 2063a: Determine a second frame sampling step for the non-key frames in response to the quantity of key frames being less than the quantity of target sampling frames.

In some embodiments, non-key frames include a forward difference frame and a bi-directional difference frame. The forward difference frame is a video frame that stores difference data between the video frame and a previous video frame. For example, when the forward difference frame is decoded, a previously buffered picture may be superposed on a difference defined by the present forward difference frame, so that a final picture can be generated. The key frame completely reserves all content of the frame of picture, and does not refer to another picture frame. Coding is performed only by using information of the present frame, and a final picture frame may be generated. During decoding, only the present frame of data may be used to decode the key frame. It can be learned that, compared with the key frame, the forward difference frame does not completely reserve all content of the present frame of picture, but reserves only a difference between the present frame and the previous frame. In some embodiments, the forward difference frame may be a P frame, for example, the P frame is a difference frame, and the P frame has no complete picture data, and only has data that is differentiated from a picture of a previous frame. The P frame represents a difference between a current frame and a previous key frame (or a P frame). The P frame uses a previous I frame or P frame to perform inter-frame prediction coding in a motion prediction manner. During decoding of the P frame, a difference defined by the present frame may be superposed on a previously buffered picture to generate a final picture. A bi-directional difference frame refers to a video frame that stores differential data between the video frame and two frames before and after the video frame. During decoding of the bi-directional difference frame, the frames before and after the bi-directional difference frame are depended, for example, not only a previously buffered picture should be obtained, but also a later picture may be decoded, and a final picture is obtained by superposing the pictures before and after the bi-directional difference frame on the present frame of data. In some embodiments, the bi-directional difference frame may be a B frame.

In some embodiments, a second frame sampling step for a non-key frame may be determined in the following manner: First, a quantity of forward difference frames is obtained; then, a second ratio between the quantity of forward difference frames and the non-key frame sampling quantity is determined; and finally, rounding processing is performed on the second ratio to obtain the second frame sampling step.

Operation 2063b: Determine a difference between the quantity of target sampling frames and the quantity of key frames as a non-key frame sampling quantity.

Operation 2063c: Determine all key frames as the target sampling frames.

In some embodiments, all the key frames are determined as the target sampling frames. In this case, because the quantity of target sampling frames is not yet reached, video frames having the non-key frame sampling quantity further may be sampled from the non-key frames.

Operation 2063d: Determine target sampling frames having the non-key frame sampling quantity from the non-key frames based on the second frame sampling step.

Herein, a non-key frame sequence may be formed for all non-key frames in the to-be-decoded video. In a sampling process, target sampling frames having the non-key frame sampling quantity may be obtained by performing sampling in the non-key frame sequence according to the second frame sampling step. The first frame in the non-key frame sequence is a target sampling frame that may be sampled, and then one target sampling frame is sampled at an interval of the second frame sampling step.

In some embodiments, the non-key frames include a forward difference frame and a bi-directional difference frame, and the bi-directional difference frame may be removed from the video frame sequence corresponding to the to-be-decoded video. In this way, when target sampling frames having the non-key frame sampling quantity are determined from the non-key frames, the target sampling frames having the non-key frame sampling quantity may be determined from the forward difference frames based on the second frame sampling step. For example, the determined target sampling frames include a key frame and a forward difference frame, and the bi-directional difference frame may not be sampled.

For example, the key frame may be an I frame, the forward difference frame may be a P frame, and the bi-directional difference frame may be a B frame. When the quantity of key frames is less than the quantity of target sampling frames, for example, when a quantity of I frames is less than a total quantity of frames to be sampled, all I frames may be sampled, and at the same time, some P frames may be sampled. When P frames are sampled, a uniform sampling manner may be used, for example, a quantity of frames is obtained through sampling by using the second frame sampling step from a frame sequence formed by multiple P frames. A sum of a quantity of all I frames and a quantity of sampled P frames is equal to the quantity of target sampling frames.

Operation 207: The server obtains corresponding rendering data from a frame buffer of each of the target sampling frames.

In some embodiments, during determining of the target sampling frame, a frame index of each target sampling frame may be determined, so that an address of a frame buffer corresponding to each target sampling frame is determined from the frame buffer sequence of the to-be-decoded video based on the frame index of each target sampling frame. After the address of the frame buffer is determined, the rendering data of each target sampling frame may be extracted from the frame buffer.

Some embodiments provide a method for determining a target sampling frame and a frame index, including the following operations: first, determining a video frame sequence formed by key frames and non-key frames; obtaining a frame index sequence corresponding to the video frame sequence; determining target sampling frames from the video frame sequence based on a quantity of key frames; and determining a frame index of each target sampling frame based on the frame index sequence.

Operation 208: The server performs video decoding on the to-be-decoded video based on the rendering data of the target sampling frames, to obtain a decoded video corresponding to the to-be-decoded video.

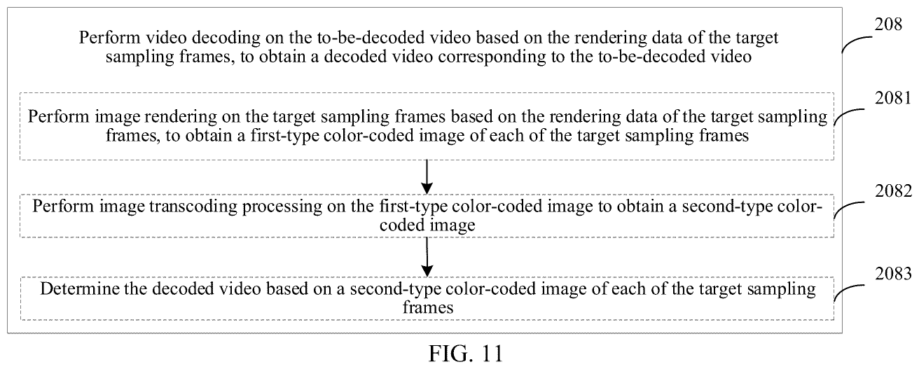

In some embodiments, the frame buffer may include a video frame array, where the video frame array may include buffer data used when image rendering is performed on the video frame, the buffer data may include decoding information for decoding the video frame, and the buffer data is the rendering data of the target sampling frame. Referring to FIG. 11, FIG. 11 shows that operation 208 may be implemented by using the following operations 2081 to 2083:

Operation 2081: Perform image rendering on the target sampling frames based on the rendering data of the target sampling frames, to obtain a first-type color-coded image of each of the target sampling frames.

For example, the first-type color-coded image may be an image in a YUV format. The YUV format is a color coding method, Y represents brightness, U and V represent chroma, and the YUV format is mainly configured for optimizing transmission of a color video signal. An image obtained after video decoding is in a YUV format.

Operation 2082: Perform image transcoding processing on the first-type color-coded image to obtain a second-type color-coded image.

For example, the second-type color-coded image may be an image in an RGB format. The RGB format is a color standard in the industry. Various colors are obtained by changing the red (R), green (G), and blue (B) color channels and adding them together. RGB represents colors of red, green, and blue channels.

In some embodiments, image transcoding processing may be performed by using a conversion formula between a YUV format image and an RGB format image, to obtain an RGB format image.

Operation 2083: Determine the decoded video based on a second-type color-coded image of each of the target sampling frames.

Herein, image decoding may be performed on the second-type color-coded image of each target sampling frame to obtain the decoded video.

Operation 209: The server sends the decoded video to the terminal.

Operation 210: The terminal displays the decoded video on a current interface.

Operation 211: The terminal generates a video recognition request for the to-be-decoded video.

In some embodiments, after receiving the decoded video, the terminal may further request the server to recognize the decoded video, thereby implementing recognition of the original to-be-decoded video.

Operation 212: The terminal sends the video recognition request to the server.

Operation 213: The server performs recognition on the decoded video in response to the video recognition request to obtain a video recognition result.

Operation 214: The server sends the video recognition result to the terminal.

According to the video decoding method provided in some embodiments, a frame type of each video frame is determined based on frame attribute information in a frame data packet of each video frame in a to-be-decoded video. The frame type includes an I frame, a P frame, and a B frame. Then, target sampling frames are determined from I frames, P frames, and B frames based on a quantity of key frames. During determining of the target sampling frames, I frames are first sampled. If a quantity of I frames can meet a sampling condition, all target sampling frames are determined from the I frames. If the quantity of I frames cannot meet the sampling condition, all I frames are determined as target sampling frames, and at the same time, some target sampling frames are sampled from the P frames. In this way, because decoding of the I frames and the P frames may not depend on the B frames, after a sequence is reorganized for the target sampling frames obtained through sampling, each frame can still be normally decoded. In addition, by removing the B frames, inter-frame redundancy can be reduced and a decoding process can be accelerated, thereby improving video decoding efficiency.

The following describes an exemplary application of some embodiments in an actual application scenario.

Some embodiments provide a video decoding method based on fast uniform frame capture of key frame extraction. In this method, a quantity of video key frames (I frames) and time stamp distribution are first obtained, and it is determined, according to the quantity of key frames, whether another non-key frame may be decoded. If the quantity of key frames already meets a quantity of frames that are expected to be obtained by uniform frame capture, the key frames are decoded directly and then extracted uniformly. Otherwise, the key frames are decoded preferentially, and then the remaining non-key frames are decoded for padding. In addition, considering that a picture of a frame B is similar to a picture of a P frame adjacent to the frame B, and that decoding of the frame B may depend on frames before and after the frame B, in some embodiments, only the P frame is considered during decoding of a non-key frame, thereby increasing a decoding speed. Compared with the uniform frame capture-based video decoding method, in some embodiments, a key frame is preferentially extracted. While captured video frames can represent one video to a maximum extent, similar redundant frame decoding can be reduced. In addition, because more key frames are set for a long video during coding, some embodiments has clearer effects on decoding acceleration of the long video. The video decoding method in some embodiments may be applied to all applications that use video decoding, such as action recognition and video content description.

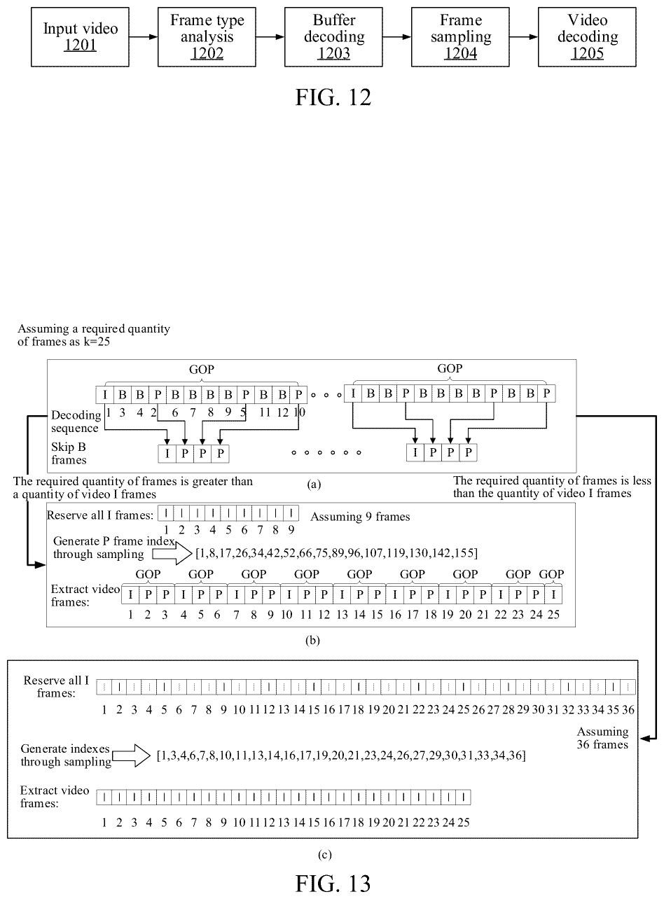

FIG. 12 is a schematic diagram of an application process of a video decoding method according to some embodiments. As shown in FIG. 12, in the video decoding method in some embodiments, first video stream analysis (for example, frame type analysis 1202) is performed on an input video 1201, to obtain a type of each frame, count distribution of I frames and P frames, discard B frames, and perform sequence reassembly on the remaining I frames and P frames. Then, buffer decoding 1203 is performed on a reassembled video sequence. Because decoding of the I frames and the P frames may not depend on the B frames, each frame can still be normally decoded from the reassembled sequence. A process of frame sampling 1204 is implemented by determining whether the P frames may be decoded according to a quantity of I frames. If the quantity of I frames meets a desired quantity of frames, sampling and video decoding 1205 are directly performed on the I frames. Otherwise, all the I frames are decoded first and then the P frames are sampled for padding.

The following describes the frame type analysis operation in some embodiments.

In a video coding and decoding process, video frames are encapsulated in different frame data packets. The frame data packet includes not only content (for example, rendering data) for decoding the video frame, but also a type of the video frame (an I frame, a P frame, or a B frame). To obtain a frame type of each video frame, it is only necessary to obtain attribute information in the frame data packet, and it is unnecessary to decode the video frame. Before decoding, types of all video frames may be obtained. Then, a quantity of key frames and a quantity of non-key frames in a to-be-decoded video can be counted. Considering that decoding of the B frame depends on frames before and after the B frame, and that the picture of the B frame is similar to pictures of an I frame and a P frame adjacent to the B frame, only decoding of the I frame and the P frame is considered in some embodiments. As shown in part (a) of FIG. 13, FIG. 13 is a decoding plus frame sampling process of a frame buffer according to some embodiments.

The following describes a frame buffer decoding process in some embodiments.

Compared with the decoding method, some embodiments preferentially decodes a key frame (I frame), and then decodes a non-key frame. In frame type analysis, a quantity Iₙᵤₘ of key frames is already obtained. Assuming that a quantity of frames that may be captured is N, there are the following two cases:

The first case is: Iₙᵤₘ<N. In this case, because the quantity of key frames is less than the quantity of frames that may be intercepted, after decoding of the key frame buffer is completed, remaining non-key frames may be decoded, and then sampled for padding. Although the process still decodes all frames, the decoding process is still faster than the method because the B frame is ignored.

The second case is: Iₙᵤₘ>N. If the quantity of key frames already meets the quantity of frames that may be captured, N frames are directly uniformly sampled from the key frames for buffer decoding. In addition to ensuring that the key frames cover the entire video, the key frames can also cover a video frame whose picture changes greatly. In addition, because only the key frames are decoded, the decoding speed can be further increased.

In a frame sampling process, the foregoing two cases of the buffer decoding process are respectively related to uniform sampling of P frames and uniform sampling of I frames. Assuming that the quantity of frames is k, a position of a captured frame may be obtained according to a quantity n of video frames:

The step is calculated according to the quantity k of frames by using the following formula (1):

$$s = [ n / k ] . \qquad ( 1 )$$

[ ] is a rounding symbol, and s represents an interval between frames. If an index value of the first frame is i₁, an index value of the second frame is i₂=i₁+s, and further, an index value i_{N}=i₁+k*s of the last frame may be calculated, so as to finally obtain position information of captured frames. [i₁, i₂, i₃, . . . , iₖ]. An index value of the initial frame may be set to 1.

In the first case of buffer decoding, the quantity of P frames is k=N−Iₙᵤₘ, and the quantity n of video frames is corresponding to the total quantity of video P frames, as shown in part (b) in FIG. 13. In the second case, the quantity of I frames is k=N, and the quantity of video frames is n=Iₙᵤₘ, as shown in part (c) in FIG. 13.

The following describes the video decoding process in some embodiments.

Video decoding is a process of restoring a frame buffer in a cache to a complete image. The captured frame index information obtained based on the frame sampling process may be converted from the buffered video frame sequence to obtain a corresponding video frame array (the video frame array includes rendering data of the video frame). In some embodiments, a video frame format is YUV, and still may be converted into an RGB image through transcoding. Converting the YUV format into the RGB format may be implemented according to the following formulas (2) to (4):

$$R = Y + 1.403 * V ; \qquad ( 2 )$$

$$G = Y - 0.344 * U - 0.714 * V ; \qquad ( 3 )$$

$$B = Y + 1.77 * U . \qquad ( 4 )$$

A pixel value range of RGB may be further limited to [0, 255]. The foregoing formulas may be further written as the following formulas (5) to (7):

$$R = Y + 1.403 * ( V - 128 ) ; \qquad ( 5 )$$

$$G = Y - 0.344 * ( U - 128 ) - 0.714 * ( V - 128 ) ; \qquad ( 6 )$$

$$B = Y + 1.77 * ( U - 128 ) . \qquad ( 7 )$$

The following uses an example to describe an application of the method in some embodiments.

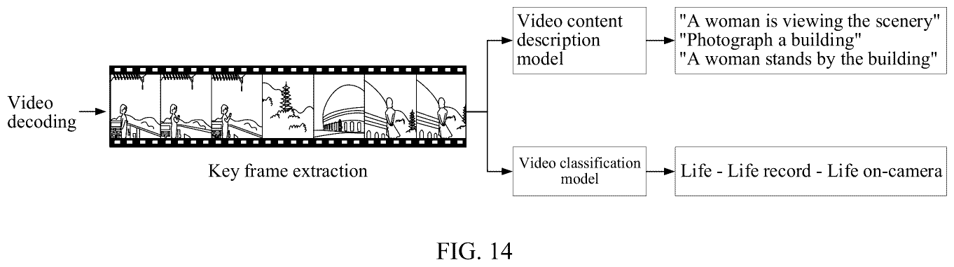

Some embodiments serves as a common video uniform frame capture method, and may be applied to scenarios such as video classification and video content description. As shown in FIG. 14, a video key frame can be extracted from an input video by using the method in some embodiments. Compared with the method, in some embodiments, a key frame can be configured for decoding some video frames whose picture changes greatly, so that redundancy between decoded picture frames is minimized. The decoded video frame is sent to a video content description model and a video classification model for further prediction, to obtain a group of description and video type information separately.

In some embodiments, fast video uniform decoding is implemented based on the GOP concept from two perspectives of key frame decoding and non-key frame de-redundancy. Advantages of some embodiments are at least as follows: First, only I frames and P frames are considered for decoding, so that redundant non-key frames are reduced, and decoding acceleration is implemented. Second, key frames are decoded preferentially, so as to ensure that frames whose picture changes greatly are decoded, so as to reduce a miss.

Some embodiments may be applied to all applications that use video decoding. For non-key frames, in addition to P frames in some embodiments, P frames and B frames may be used at the same time. In addition, the key frame-based decoding may be used in addition to uniform frame capture, and may be further used in continuous frame capture, for example, consecutive P frames after the I frame are selected, so as to maintain the time sequence of the video frames.

In some embodiments, content of user information is involved, for example, information such as a to-be-decoded video, a decoded video, and a video recognition result. If data related to user information or enterprise information is involved, when some embodiments are applied to a product or technology, a user's permission or consent should be obtained, and related data collection, use, and processing should comply with relevant laws and standards of a relevant country and region.

The following continues to describe an example structure of a video decoding apparatus 354 provided in some embodiments when implemented as software modules. In some embodiments, as shown in FIG. 5, the video decoding apparatus 354 includes: a video stream analysis module 3541, configured to perform video stream analysis on a to-be-decoded video to obtain a frame data packet of each video frame in the to-be-decoded video; the video stream analysis referring to parsing an encapsulated data packet that encapsulates video frame information in the to-be-decoded video; the video stream analysis referring to parsing an encapsulated data packet that encapsulates video frame information in the to-be-decoded video; a first determining module 3542, configured to determine a frame type of each video frame based on frame attribute information in the frame data packet; the frame type including a key frame and a non-key frame; a second determining module 3543, configured to: determine multiple target sampling frames from the to-be-decoded video based on a quantity of key frames, the target sampling frames being video frames configured for providing rendering data when rendering the to-be-decoded video, and the rendering data being stored in frame buffers respectively corresponding to the target sampling frames; an obtaining module 3544, configured to obtain corresponding rendering data from a frame buffer of each of the target sampling frames; and a video decoding module 3545, configured to perform video decoding on the to-be-decoded video based on the rendering data to obtain a decoded video corresponding to the to-be-decoded video.

In some embodiments, the second determining module 3543 is further configured to: set a quantity of target sampling frames; and determine target sampling frames that all come from the key frames based on the quantity of key frames and the quantity of target sampling frames; or determine target sampling frames from all key frames and some non-key frames based on the quantity of key frames and the quantity of target sampling frames.

In some embodiments, the second determining module 3543 is further configured to: determine an application scenario type of the decoded video, and set the quantity of target sampling frames based on the application scenario type; or set the quantity of target sampling frames based on video duration of the to-be-decoded video.

In some embodiments, the second determining module 3543 is further configured to: determine a first frame sampling step for the key frames in response to the quantity of key frames being greater than the quantity of target sampling frames; determine target sampling frames having the quantity from the key frames based on the first frame sampling step; and determine all key frames as the target sampling frames in response to the quantity of key frames being equal to the quantity of target sampling frames.

In some embodiments, the second determining module 3543 is further configured to: determine a first ratio between the quantity of key frames and the quantity of target sampling frames; and perform rounding processing on the first ratio to obtain the first frame sampling step.

In some embodiments, the second determining module 3543 is further configured to: determine a second frame sampling step for the non-key frames in response to the quantity of key frames being less than the quantity of target sampling frames; determine a difference between the quantity of target sampling frames and the quantity of key frames as a non-key frame sampling quantity; determine all key frames as the target sampling frames; and determine target sampling frames having the non-key frame sampling quantity from the non-key frames based on the second frame sampling step.

In some embodiments, the non-key frames include forward difference frames and bi-directional difference frames; the apparatus further includes: a processing module, configured to delete the bi-directional difference frames from a video frame sequence corresponding to the to-be-decoded video; and the second determining module 3543 is further configured to: determine the target sampling frames having the non-key frame sampling quantity from the forward difference frames based on the second frame sampling step.

In some embodiments, the second determining module 3543 is further configured to: obtain a quantity of forward difference frames; determine a second ratio between the quantity of forward difference frames and the non-key frame sampling quantity; and perform rounding processing on the second ratio to obtain the second frame sampling step.

In some embodiments, the first determining module 3542 is further configured to: obtain the frame attribute information in the frame data packet; the frame attribute information including a frame type of a corresponding video frame; and parse the frame attribute information to obtain a frame type of a video frame corresponding to the frame data packet.

In some embodiments, the second determining module 3543 is further configured to: determine a video frame sequence formed by the key frames and the non-key frames; obtain a frame index sequence corresponding to the video frame sequence; determine the target sampling frames from the video frame sequence based on the quantity of key frames; and determine a frame index of each of the target sampling frames based on the frame index sequence.

In some embodiments, the obtaining module 3544 is further configured to: obtain the frame buffer of each of the target sampling frames from a frame buffer sequence of the to-be-decoded video based on the frame index of each of the target sampling frames.

In some embodiments, the video decoding module 3545 is further configured to: perform image rendering on the target sampling frames based on the rendering data of the target sampling frames, to obtain a first-type color-coded image of each of the target sampling frames; perform image transcoding processing on the first-type color-coded image to obtain a second-type color-coded image; and determine the decoded video based on a second-type color-coded image of each of the target sampling frames.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The descriptions of the apparatus in some embodiments are similar to the foregoing descriptions of the method, have beneficial effects similar to those of the method. For implementation details of the apparatus, reference may be made to the descriptions of the method according to some embodiments.

Some embodiments provide a computer program product, where the computer program product includes executable instructions, and the executable instructions are computer instructions. The executable instructions are stored in a computer-readable storage medium. When a processor of an electronic device reads the executable instructions from the computer-readable storage medium, and the processor executes the executable instructions, the electronic device is enabled to perform the method in some embodiments.

Some embodiments provide a storage medium having executable instructions stored therein. When the executable instructions are executed by a processor, the processor is caused to perform the method provided in some embodiments, for example, the method shown in FIG. 6.

In some embodiments, the storage medium may be a computer-readable storage medium, for example, a memory such as a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disc, or a compact disc read-only memory (CD-ROM); or may be any device that includes one or any concatenation of the foregoing memories.

In some embodiments, the executable instructions may be compiled in a form of a program, software, a software module, a script, or code, in any form of a programming language (including a compilation or interpretation language, or a declarative or procedural language), and may be deployed in any form, including being deployed as an independent program or as a module, component, subroutine, or another unit for use in a computing environment.

As an example, the executable instructions may be but are not necessarily corresponding to a file in a file system, and may be stored in a part of a file that stores another program or data, for example, stored in one or more scripts in a Hypertext Markup Language (HTML) document, stored in a single file dedicated to a program under discussion, or stored in a plurality of synchronous files (for example, a file that stores one or more modules, subprograms, or code parts). As an example, the executable instruction may be deployed on one electronic device for execution, or executed on multiple electronic devices located at one location, or executed on multiple electronic devices distributed at multiple locations and interconnected by using a communications network.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A video decoding method, performed by an electronic device, comprising:
performing video stream analysis on a to-be-decoded video to obtain a frame data packet of a first plurality of video frames in the to-be-decoded video, wherein the video stream analysis comprises parsing an encapsulated data packet that encapsulates video frame information in the to-be-decoded video;
determining a plurality of frame types of the first plurality of video frames based on frame attribute information in the frame data packet, a frame type comprising a key frame and a non-key frame;
determining a first plurality of target sampling frames from the to-be-decoded video based on a first quantity of a plurality of key frames, the first plurality of target sampling frames being a second plurality of video frames configured for providing rendering data when rendering the to-be-decoded video, and the rendering data being stored in a plurality of frame buffers corresponding to the first plurality of target sampling frames;
obtaining the rendering data from the plurality of frame buffers; and
performing video decoding on the to-be-decoded video based on the rendering data to obtain a decoded video corresponding to the to-be-decoded video.

2. The video decoding method according to claim 1, wherein the determining the first plurality of target sampling frames comprises:
setting a second quantity of the first plurality of target sampling frames; and
determining a second plurality of target sampling frames that come from the plurality of key frames based on the first quantity and the second quantity, or determining a third plurality of target sampling frames from the plurality of key frames and one or more non-key frames based on the first quantity and the second quantity.

3. The video decoding method according to claim 2, wherein the setting the second quantity comprises:
determining an application scenario type of the decoded video; and
setting the second quantity based on the application scenario type, or setting the second quantity based on a duration of the to-be-decoded video.

4. The video decoding method according to claim 2, wherein the determining the second plurality of target sampling frames comprises:
determining a first frame sampling step for the plurality of key frames based on the first quantity being greater than the second quantity;
determining a fourth plurality of target sampling frames having the first quantity based on the first frame sampling step; and
determining the plurality of key frames as the second plurality of target sampling frames based on the first quantity being equal to the second quantity.

5. The video decoding method according to claim 4, wherein the determining the first frame sampling step comprises:
determining a first ratio between the first quantity and the second; and
performing rounding processing on the first ratio to obtain the first frame sampling step.

6. The video decoding method according to claim 2, wherein the determining the second plurality of target sampling frames comprises:
determining a second frame sampling step for the one or more non-key frames based on the first quantity being less than the second quantity;
determining a difference between the second quantity and the first quantity as a non-key frame sampling quantity;
determining the plurality of key frames as the second plurality of target sampling frames; and
determining a fourth plurality of target sampling frames having the non-key frame sampling quantity from the one or more non-key frames based on the second frame sampling step.

7. The video decoding method according to claim 6, wherein the one or more non-key frames comprise a plurality of forward difference frames and a plurality of bi-directional difference frames,
wherein the method further comprises deleting the plurality of bi-directional difference frames from a video frame sequence corresponding to the to-be-decoded video, and
wherein the determining the fourth plurality of target sampling frames comprises:
determining a fifth plurality of target sampling frames having the non-key frame sampling quantity from the plurality of forward difference frames based on the second frame sampling step.

8. The video decoding method according to claim 7, wherein the determining the second frame sampling step comprises:
obtaining a third quantity of the plurality of forward difference frames;
determining a second ratio between the third quantity and the non-key frame sampling quantity; and
performing rounding processing on the second ratio to obtain the second frame sampling step.

9. The video decoding method according to claim 1, wherein the determining the frame type comprises:
obtaining the frame attribute information in the frame data packet, the frame attribute information comprising a first frame type of a corresponding video frame; and
parsing the frame attribute information to obtain a second frame type of a video frame corresponding to the frame data packet.

10. The video decoding method according to claim 2, wherein the determining the second plurality of target sampling frames comprises:
determining a video frame sequence formed by the plurality of key frames and the one or more non-key frames;
obtaining a frame index sequence corresponding to the video frame sequence;
determining the second plurality of target sampling frames from the video frame sequence based on the first quantity; and determining a plurality of frame indexes of the second plurality of target sampling frames based on the frame index sequence.

11. A video decoding apparatus, comprising:
at least one memory configured to store computer program code; and
at least one processor configured to read the program code and operate as instructed by the program code, the program code comprising:
video stream analysis code configured to cause at least one of the at least one processor to perform video stream analysis on a to-be-decoded video to obtain a frame data packet of a first plurality of video frames in the to-be-decoded video, wherein the video stream analysis comprises parsing an encapsulated data packet that encapsulates video frame information in the to-be-decoded video;
first determining code configured to cause at least one of the at least one processor to determine a plurality of frame types of the first plurality of video frames based on frame attribute information in the frame data packet, a frame type comprising a key frame and a non-key frame;
second determining code configured to cause at least one of the at least one processor to determine a first plurality of target sampling frames from the to-be-decoded video based on a first quantity of a plurality of key frames, the first plurality of target sampling frames being a second plurality of video frames configured for providing rendering data when rendering the to-be-decoded video, and the rendering data being stored in a plurality of frame buffers corresponding to the first plurality of target sampling frames;
obtaining code configured to cause at least one of the at least one processor to obtain the rendering data from the plurality of frame buffers; and
video decoding code configured to cause at least one of the at least one processor to perform video decoding on the to-be-decoded video based on the rendering data to obtain a decoded video corresponding to the to-be-decoded video.

12. The video decoding apparatus according to claim 11, wherein the second determining code is configured to cause at least one of the at least one processor to:
set a second quantity of the first plurality of target sampling frames; and
determine a second plurality of target sampling frames that come from the plurality of key frames based on the first quantity and the second quantity, or determine a third plurality of target sampling frames from the plurality of key frames and one or more non-key frames based on the first quantity and the second quantity.

13. The video decoding apparatus according to claim 12, wherein the setting the second determining code is configured to cause at least one of the at least one processor to:
determine an application scenario type of the decoded video; and
setting the second quantity based on the application scenario type, or setting the second quantity based on a duration of the to-be-decoded video.

14. The video decoding apparatus according to claim 12, wherein the second determining code is configured to cause at least one of the at least one processor to:
determine a first frame sampling step for the plurality of key frames based on the first quantity being greater than the second quantity;
determine a fourth plurality of target sampling frames having the first quantity based on the first frame sampling step; and
determine the plurality of key frames as the second plurality of target sampling frames based on the first quantity being equal to the second quantity.

15. The video decoding apparatus according to claim 14, wherein the second determining code is configured to cause at least one of the at least one processor to:
determine a first ratio between the first quantity and the second; and
perform rounding processing on the first ratio to obtain the first frame sampling step.

16. The video decoding apparatus according to claim 12, wherein the second determining code is configured to cause at least one of the at least one processor to:
determine a second frame sampling step for the one or more non-key frames based on the first quantity being less than the second quantity;
determine a difference between the second quantity and the first quantity as a non-key frame sampling quantity;
determine the plurality of key frames as the second plurality of target sampling frames; and
determine a fourth plurality of target sampling frames having the non-key frame sampling quantity from the one or more non-key frames based on the second frame sampling step.

17. The video decoding apparatus according to claim 16, wherein the one or more non-key frames comprise a plurality of forward difference frames and a plurality of bi-directional difference frames,
wherein the program code further comprises deleting code configured to cause at least one of the at least one processor to delete the plurality of bi-directional difference frames from a video frame sequence corresponding to the to-be-decoded video, and
wherein the second determining code is configured to cause at least one of the at least one processor to determine a fifth plurality of target sampling frames having the non-key frame sampling quantity from the plurality of forward difference frames based on the second frame sampling step.

18. The video decoding apparatus according to claim 17, wherein the second determining code is configured to cause at least one of the at least one processor to:
obtain a third quantity of the plurality of forward difference frames;
determine a second ratio between the third quantity and the non-key frame sampling quantity; and
perform rounding processing on the second ratio to obtain the second frame sampling step.

19. The video decoding apparatus according to claim 11, wherein the first determining code is configured to cause at least one of the at least one processor to:
obtain the frame attribute information in the frame data packet, the frame attribute information comprising a first frame type of a corresponding video frame; and
parse the frame attribute information to obtain a second frame type of a video frame corresponding to the frame data packet.

20. A non-transitory computer-readable storage medium, storing computer code which, when executed by at least one processor, causes the at least one processor to at least:
perform video stream analysis on a to-be-decoded video to obtain a frame data packet of a first plurality of video frames in the to-be-decoded video, wherein the video stream analysis comprises parsing an encapsulated data packet that encapsulates video frame information in the to-be-decoded video;
determine a plurality of frame types of the first plurality of video frames based on frame attribute information in the frame data packet, a frame type comprising a key frame and a non-key frame;
determine a first plurality of target sampling frames from the to-be-decoded video based on a first quantity of a plurality of key frames, the first plurality of target sampling frames being a second plurality of video frames configured for providing rendering data when rendering the to-be-decoded video, and the rendering data being stored in a plurality of frame buffers corresponding to the first plurality of target sampling frames;
obtain the rendering data from the plurality of frame buffers; and
perform video decoding on the to-be-decoded video based on the rendering data to obtain a decoded video corresponding to the to-be-decoded video.
